(19) United States
(12) Patent Application Publication
(10) Pub. No.: US 2004/0213584 A1
(43) Pub. Date: Oct. 28, 2004

(54) Optical signal processing apparatus

(75) Inventors: Shun-ichi Miyazaki, Tokyo (JP); Akira Miura, Tokyo (JP); Sadaharu Oka, Tokyo (JP); Chie Sato, Tokyo (JP); Tsuyoshi Yakihara, Tokyo (JP); Shinji Kobayashi, Tokyo (JP); Morio Wada, Tokyo (JP); Hirotoshi Kodaka, Tokyo (JP); Toshimasa Umezawa, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 10/813,116

(22) Filed: Mar. 31, 2004

(30) Foreign Application Priority Data
Apr. 24, 2003 (JP) 2003-119321

(51) Int. Cl. H04B 10/06

(52) U.S. Cl. 398/202

(57) ABSTRACT

An optical signal processing apparatus capable of performing high-speed operation is to be realized. According to this invention, at least one photodiode for converting an optical signal to an electrical signal, and a resonant tunneling diode for having the electrical signal of this photodiode inputted thereto and performing switch operation are provided to acquire a digital signal.

### BACKGROUND OF THE INVENTION

1. Field of the Invention

This invention relates to an optical signal processing apparatus capable of performing high-speed operation.

2. Description of the Related Art

Conventionally, an optical repeater has three functions of reshaping, retiming and regeneration. Such an optical repeater is shown, for example, in FIG. 6 of JP-A-2000-59313. Even when distortion and noise due to transmission are generated in the waveform of optical data signals, this optical repeater temporarily reproduces these signals to electrical digital signals, then converts them to optical signals again and transmits the optical signals. Therefore, deterioration in signal quality that occurred on the stage preceding the repeater can be eliminated.

Since such an optical repeater is of a large scale, an apparatus as shown in FIG. 1 of JP-A-2000-59313 has been proposed. This apparatus will now be described with reference to FIG. 1.

In FIG. 1, a photodiode 1 has input light inputted thereto and converts it to an electrical signal. An amplifier 2 has the electrical signal inputted thereto and amplifies the signal. An electroabsorption (EA) optical modulator 3 has its transmittance changed by the electrical signal from the amplifier 2, and modulates and outputs light.

The operation of such an apparatus will now be described. The photodiode 1 has an optical signal inputted thereto, converts it to an electrical signal and outputs the electrical signal to the amplifier 2. The amplifier 2 amplifies the signal and outputs the amplified signal to the electroabsorption optical modulator 3. The electroabsorption optical modulator 3 modulates light using the signal from the amplifier 2 and outputs an optical signal.

This apparatus cannot perform waveform shaping when an optical signal is dull. Thus, it is proposed that the amplifier 2 is provided with a waveform shaping function in the case of performing waveform shaping.

Recently, however, while operation of 100 GHz or more has been demanded because of the high speed of optical signals, there is a problem that high-speed operation cannot be realized with the amplifier 2.

### SUMMARY OF THE INVENTION

It is an object of this invention to realize an optical signal processing apparatus capable of performing high-speed operation.

### BRIEF DESCRIPTION OF THE DRAWINGS

FIG. 1 is a view showing the structure of a conventional optical repeater.

FIG. 2 is a structural view showing a first embodiment of this invention.

FIG. 3 is a view showing the specific structure of an apparatus shown in FIG. 2.

FIG. 4 is a view for explaining the operation of the apparatus shown in FIGS. 2 and 3.

FIG. 5 is a view for explaining the operation of the apparatus shown in FIGS. 2 and 3.

FIG. 6 is a view showing a semiconductor multilayer structure.

FIG. 7 is a view showing the structure of a semiconductor of the apparatus shown in FIG. 3.

FIG. 8 is a structural view showing a second embodiment of this invention.

FIG. 9 is a structural view showing a third embodiment of this invention.

FIG. 10 is a structural view showing a fourth embodiment of this invention.

FIG. 11 is a structural view showing a fifth embodiment of this invention.

FIG. 12 is a structural view showing a sixth embodiment of this invention.

FIG. 13 is a structural view showing a seventh embodiment of this invention.

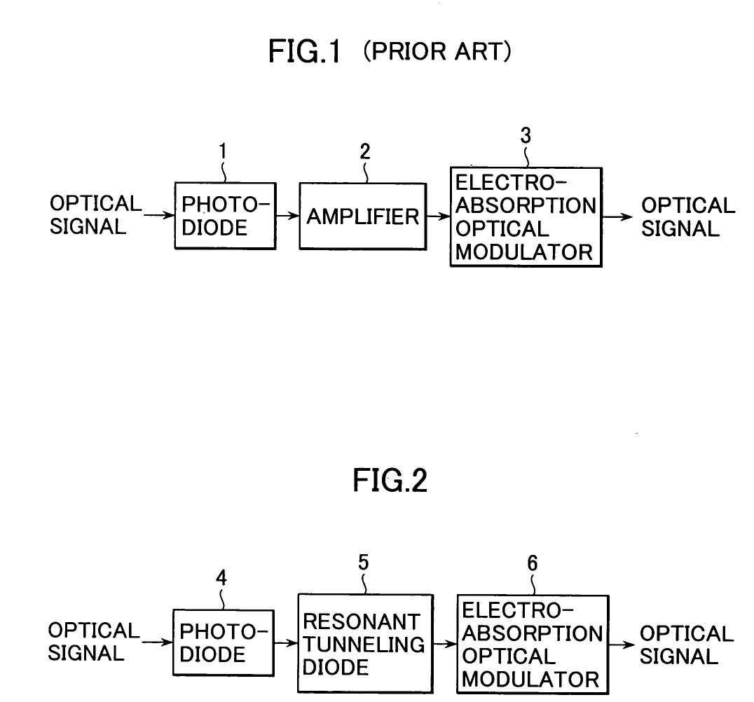

### DETAILED DESCRIPTION OF THE PREFERRED EMBODIMENTS

Embodiments of this invention will now be described with reference to the drawings.

### FIRST EMBODIMENT

FIG. 2 is a structural view showing a first embodiment of this invention. In FIG. 2, a photodiode 4 converts an optical signal (digital signal) to an electrical signal. A resonant tunneling diode 5 is a negative-resistance switch element that forms a quantum well structure and causes a resonant tunneling phenomenon of electrons by using the quantum well structure. Since the resonant tunneling diode 5 has a quantum mechanical resonance effect, it can perform switch operation to a high-speed electrical signal of 100 Gb or more. The resonant tunneling diode 5 has the electrical signal inputted thereto from the photodiode 4 and performs switch operation. An electroabsorption (EA) optical modulator 6 has its transmittance changed by the switch operation of the resonant tunneling diode 5, and modulates and outputs light.

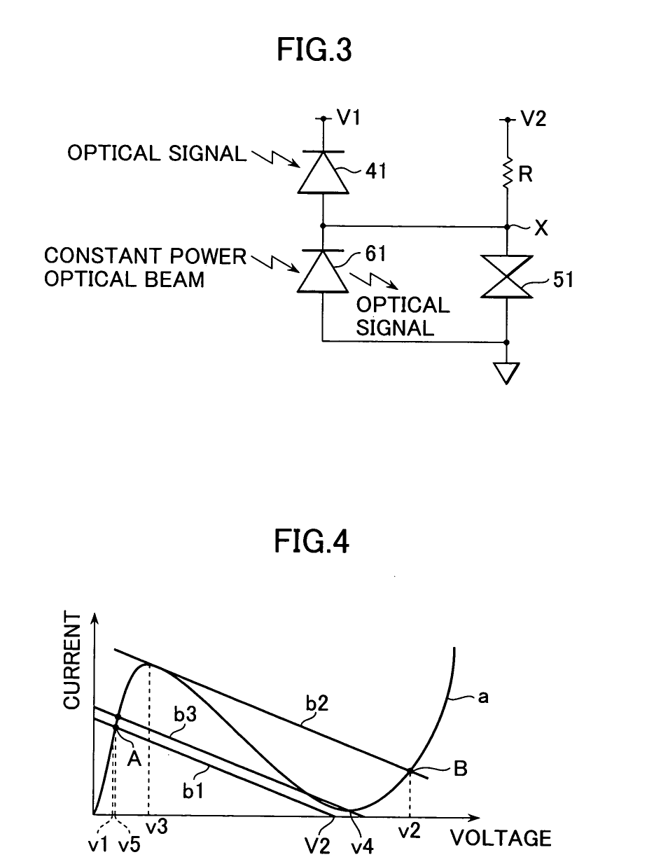

Next, the specific structure will be described with reference to FIG. 3. A photodiode 41 has an optical signal inputted thereto and has its cathode connected to a voltage V1. A resistor R has its one end connected to a voltage V2 and has its other end connected to the anode of the photodiode 41. A resonant tunneling diode 51 has its one end connected to the other end of the resistor R and has its other end grounded. The connection point between the other end of the resistor R and the resonant tunneling diode 51 is referred to as “X”. An electroabsorption optical modulator 61 has its cathode connected to one end of the resonant tunneling diode 51 and has its anode grounded. The electroabsorption optical modulator 61 has its transmittance changed, and for example, it modulates a constant power optical beam from an optical fiber and outputs the modulated beam. Although the resonant tunneling diode 51 and the electroabsorption optical modulator 61 are grounded to the same potential, they may be connected to different potentials.

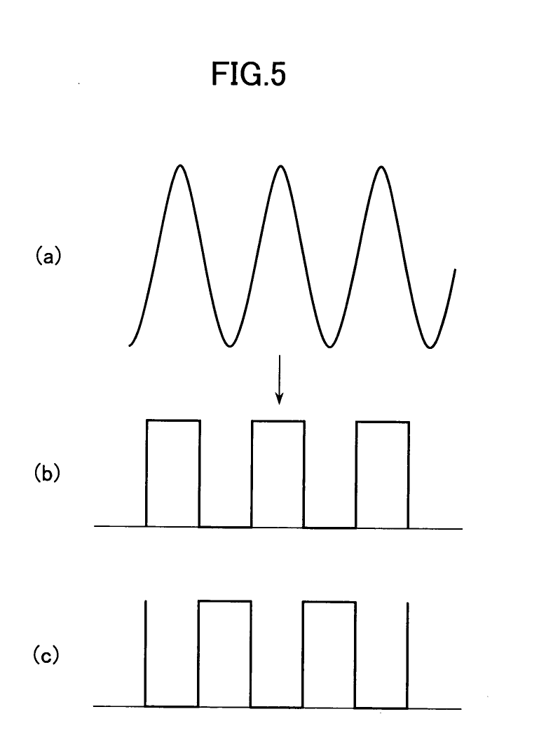

The operation of this apparatus will now be described. FIG. 4 is a view for explaining the operation of the apparatus shown in FIGS. 2 and 3, in which the horizontal axis represents voltage and the vertical axis represents current. A load characteristic curve a is load characteristic curve of the resonant tunneling diode 51, and load characteristic lines b1 to b3 are load characteristic lines of the resistor R.

When light is not inputted to the photodiode 41, no current flows through the photodiode 41. Therefore, the voltage at the connection point X is “v1”, which is decided by the intersection A of the load characteristic curve a of the resonant tunneling diode 51 and the load characteristic line b1 of the resistor R. This voltage “v1” causes the electroabsorption optical modulator 61 to have high transmittance and light is outputted.

When light is inputted to the photodiode 41, a current flows through the photodiode 41 and the resistor R has the load characteristic line “b2”. As a result, the voltage at the connection point X is “v2 (>v1)”, which is decided by the intersection B of the load characteristic curve a of the resonant tunneling diode 51 and the load characteristic line b2 of the resistor R. This voltage “v2” lowers the transmittance of the electroabsorption optical modulator 61 and light is not outputted.

When dull digital waveform light as shown in FIG. 5(a) is inputted as input light to the photodiode 41 and the input light intensifies, the current from the photodiode 41 increases. The voltage at the connection point X becomes “v3” and quickly becomes “v2”. As the current from the photodiode 41 increases, also the voltage slightly increases from “v2”.

As the input light of FIG. 5(a) begins to be weak after its peak, the current from the photodiode 41 decreases. The voltage at the connection point X becomes “v4” and quickly becomes “v5”. As the current from the photodiode 41 decreases, also the voltage slightly decreases from “v5”.

As a result, the voltage at the connection point X has a digital waveform, as shown in FIG. 5(b). This voltage controls the electroabsorption optical modulator 61 and output light shown in FIG. 5(c) is outputted. The dull input light can be reproduced to the acute digital waveform light. In the apparatus shown in FIG. 3, an optical signal that is an inversion of an inputted optical signal is outputted.

In this manner, the photodiode 41 converts an optical signal to an electrical signal, and this electrical signal causes the resonant tunneling diode 51 to perform switch operation. This switch operation causes the electroabsorption optical modulator 61 to change its transmittance and the electroabsorption optical modulator 61 modulates light. Therefore, high-speed operation can be realized with a small circuit scale.

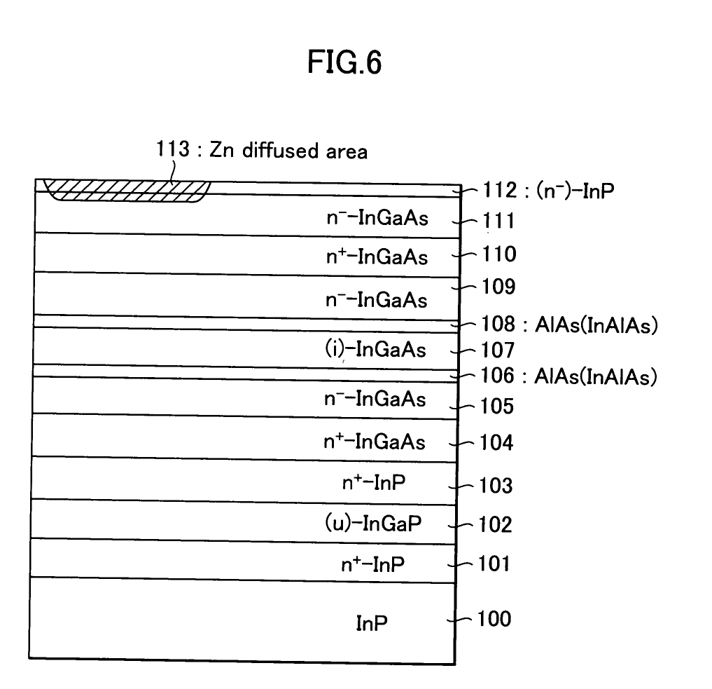

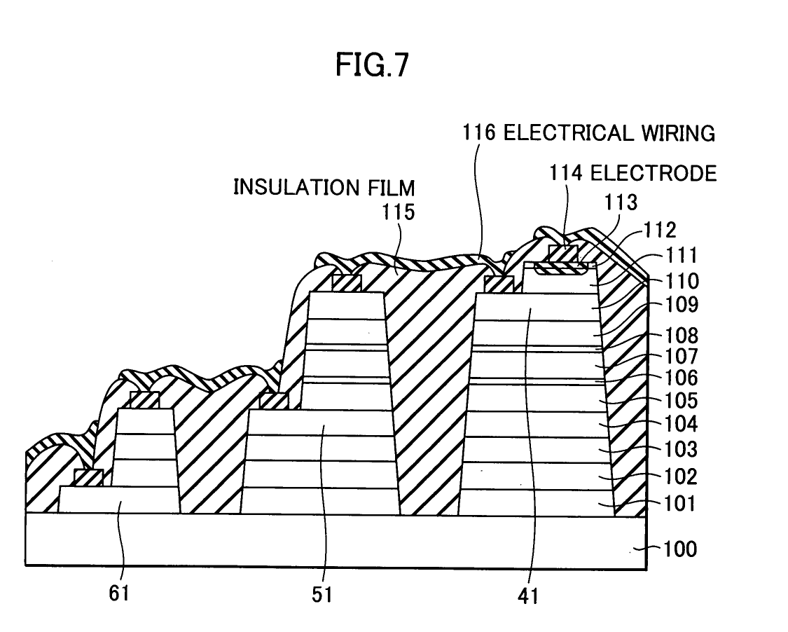

A method for manufacturing the apparatus shown in FIG. 3 will now be described with reference to FIGS. 6 and 7. FIG. 6 is a view showing a multilayer structure of a compound semiconductor. FIG. 7 is a view showing the structure of the compound semiconductor of the apparatus shown in FIG. 3.

In FIG. 6, a P⁺-InP layer 101, a (u)-InGaP layer 102, an n⁺-InP layer 103, an n⁺-InGaAs layer 104, an n⁻-InGaAs layer 105, an AlAs (InAlAs) layer 106, an (i)-InGaAs layer 107, an AlAs (InAlAs) layer 108, an n⁻-InGaAs layer 109, an n⁺-InGaAs layer 110, an n⁻-InGaAs layer 111 and an (n⁻)-InP layer 112 are stacked in order on an InP substrate 100. A Zn diffused area 113 is formed at a part of the n⁻-InGaAs layer 111 and the (n⁻)-InP layer 112.

Then, etching is performed to form an electrode 114, an insulation film 115 and an electrical wiring 116, as shown in FIG. 7. As a result, the n⁺-InGaAs layer 110 to the Zn diffused area 113 form the photodiode 41. The n⁺-InGaAs layer 104 to the n⁺-InGaAs layer 110 form the resonant tunneling diode 51. The P⁺-InP layer 101 to the n⁺-InGaAs layer 104 form the electroabsorption optical modulator 61.

Since they can be formed on the same semiconductor substrate, the photodiode 41, the resonant tunneling diode 51 and the electroabsorption optical modulator 61 can be constructed in one chip.

### SECOND EMBODIMENT

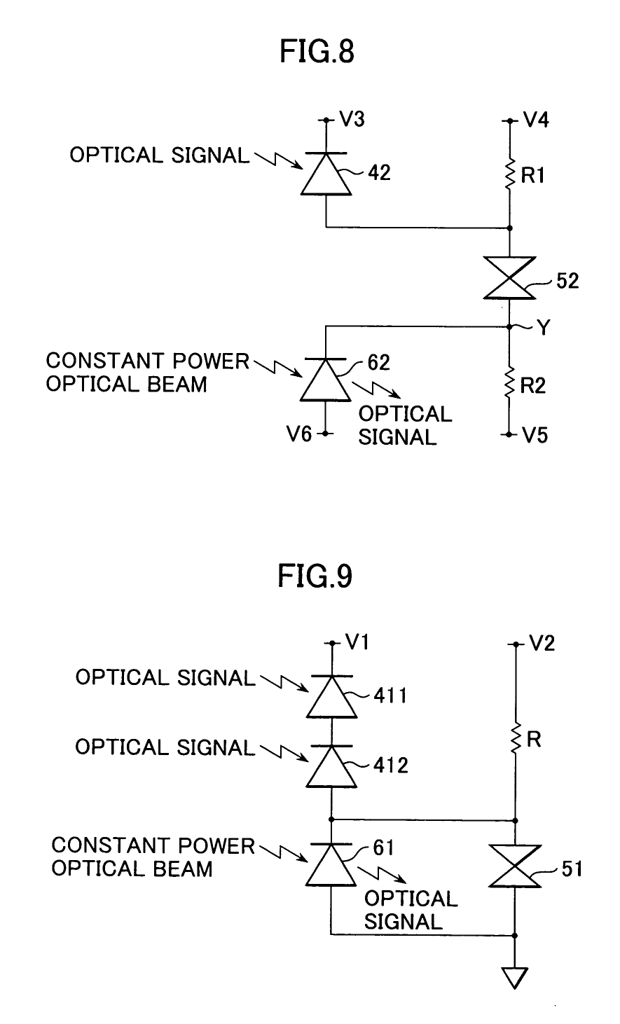

Next, a second embodiment will be described with reference to FIG. 8. In FIG. 8, a photodiode 42 has an optical signal inputted thereto and has its cathode connected to a voltage V3. A resistor R1 has its one end connected to a voltage V4 and has its other end connected to the anode of the photodiode 42. A resonant tunneling diode 52 has its one end connected to the other end of the resistor R1. A resistor R2 has its one end connected to the other end of the resonant tunneling diode 52 and has its other end connected to a voltage V5. An electroabsorption optical modulator 62 has its cathode connected to the anode of the photodiode 42 and has its anode connected to a voltage V6. The electroabsorption optical modulator 62 has its transmittance changed, and it modulates constant power optical beam and outputs the modulated beam. The relation of V3, V4>V5, V6 holds and the connection point between one end of the resistor R2 and the cathode of the electroabsorption optical modulator 62 is referred to as “Y”.

The operation of this apparatus is substantially similar to the operation of the apparatus shown in FIG. 3. However, the voltage change at the connection point Y is the reverse of the voltage change at the connection point X. Therefore, the electroabsorption optical modulator 62 can output an optical signal that is not an inversion of an inputted optical signal.

### THIRD EMBODIMENT

As an application, an example in which the optical signal processing apparatus is used for an optical logical circuit will now be described. FIG. 9 is a structural view showing a third embodiment of this invention. It shows an inverse AND circuit. In FIG. 9, the same elements as those shown in FIG. 3 are denoted by the same symbols and numerals and will not be described further in detail.

In FIG. 9, photodiodes 411, 412 are provided instead of the photodiode 41. The photodiodes 411, 412 are connected in series and have different optical signals inputted thereto, respectively. That is, the photodiode 411 has its cathode connected to the voltage V1. The photodiode 412 has its cathode connected to the anode of the photodiode 411 and has its anode connected to the other end of the resistor R.

The operation of this apparatus will be described. When light is inputted to neither of the photodiodes 411, 412, no current flows through the photodiodes 411, 412. When light is inputted to one of the photodiodes 411, 412, no current flows through the photodiode 411 or 412 to which light is not inputted, and therefore no current flows through the photodiodes 411, 412. When light is inputted to both of the photodiodes 411, 412, a current flows through the photodiodes 411, 412. The other operations are similar to the operations of the apparatus shown in FIG. 3 and therefore will not be described further in detail.

In short, the logical product of optical signals inputted to the photodiodes 411, 412 are taken and an inverted optical signal is outputted from the electroabsorption optical modulator 61.

### FOURTH EMBODIMENT

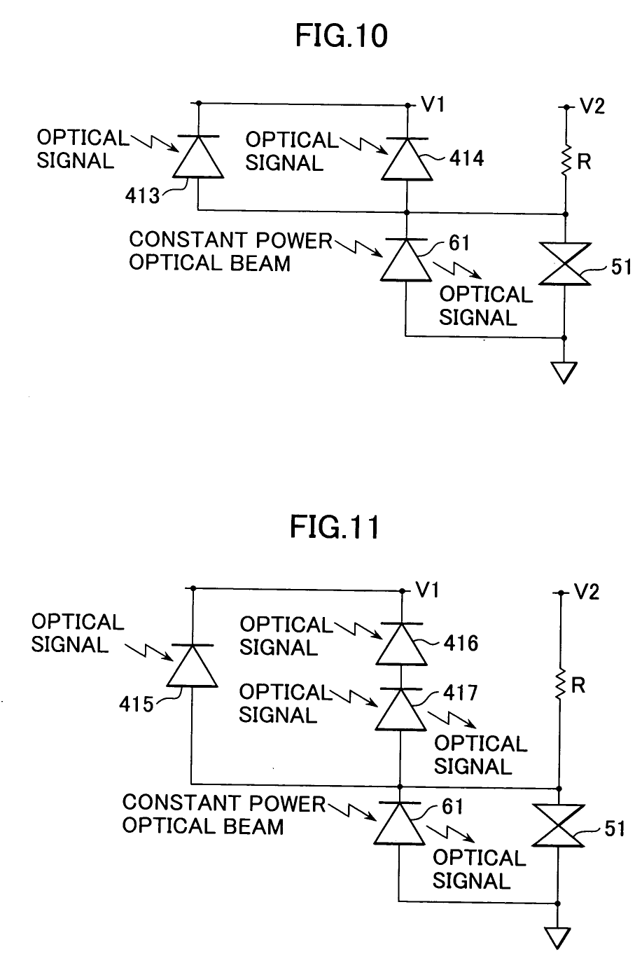

Next, a fourth embodiment of an inversion OR circuit will be described with reference to FIG. 10. In FIG. 10, the same elements as those shown in FIG. 3 are denoted by the same symbols and numerals and will not be described further in detail.

In FIG. 10, photodiodes 413, 414 are provided instead of the photodiode 41. The photodiodes 413, 414 are connected in parallel and have different optical signals inputted thereto, respectively. That is, the photodiode 413 has its cathode connected to the voltage V1 and has its anode connected to the other end of the resistor R. The photodiode 414 has its cathode connected to the voltage V1 and has its anode connected to the other end of the resistor R.

The operation of this apparatus will be described. When light is inputted to neither of the photodiodes 413, 414, no current flows through the photodiodes 413, 414. When light is inputted to at least one of the photodiodes 413, 414, a current flows through one of the photodiodes 413, 414. The other operations are similar to the operations of the apparatus shown in FIG. 3 and therefore will not be described further in detail.

In short, the logical sum of optical signals inputted to the photodiodes 413, 414 is taken and an inverted optical signal is outputted from the electroabsorption optical modulator 61.

### FIFTH EMBODIMENT

Next, an optical logical circuit formed by a combination of the third and fourth embodiments will be described with reference to FIG. 11. In FIG. 11, the same elements as those shown in FIG. 3 are denoted by the same symbols and numerals and will not be described further in detail.

In FIG. 11, photodiodes 415 to 417 are provided instead of the photodiode 41 and have different optical signals inputted thereto, respectively. The photodiode 415 has its cathode connected to the voltage V1 and has its anode connected to the other end of the resistor R. The photodiode 415 and the photodiodes 416, 417 are connected in parallel. The photodiodes 416, 417 are connected in series. The photodiodes 416 has its cathode connected to the voltage V1. The photodiode 417 has its cathode connected to the anode of the photodiode 416 and has its cathode connected to the other end of the resistor R.

The operation of this apparatus is substantially similar to the operation of the apparatuses shown in FIGS. 9 and 10. The logical product of optical signals inputted to the photodiodes 416, 417 is taken, and the logical sum of this logical product and an optical signal inputted to the photodiode 415 is taken. Then, an inverted optical signal is outputted from the electroabsorption optical modulator 61.

### SIXTH EMBODIMENT

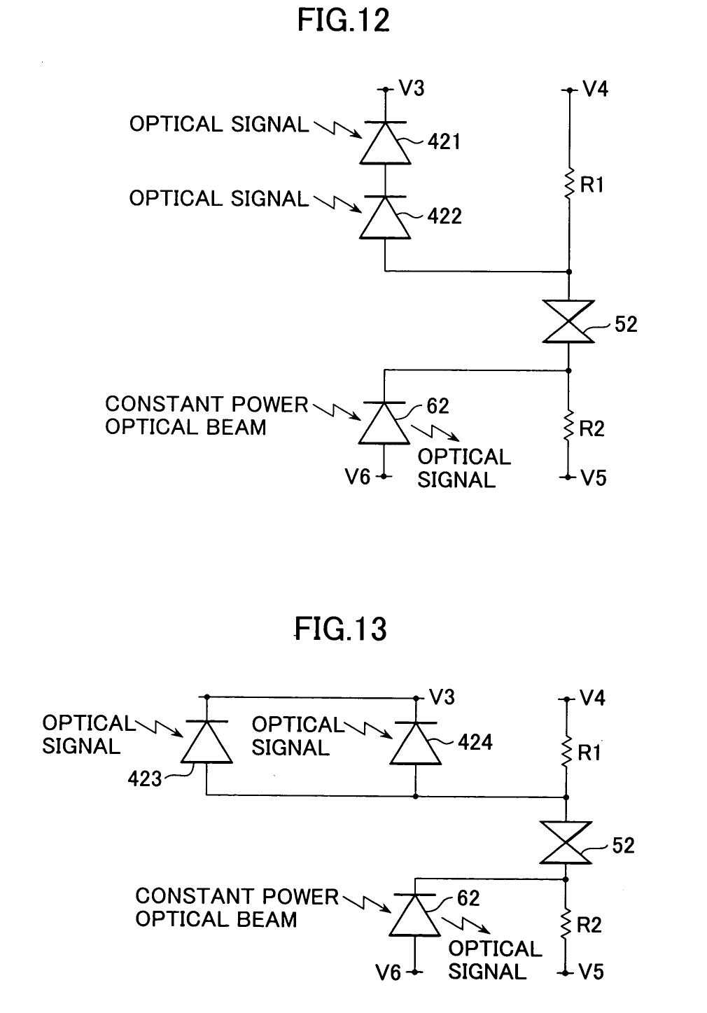

Next, another embodiment of an AND circuit will be described with reference to FIG. 12. In FIG. 12, the same elements as those shown in FIG. 8 are denoted by the same symbols and numerals and will not be described further in detail.

In FIG. 12, photodiodes 421, 422 are provided instead of the photodiode 42. The photodiodes 421, 422 are connected in series and have different optical signals inputted thereto, respectively. That is, the photodiode 421 has its cathode connected to the voltage V3. The photodiode 422 has its cathode connected to the anode of the photodiode 421 and has its anode connected to the other end of the resistor R.

The operation of this apparatus will be described. When light is inputted to neither of the photodiodes 421, 422, no current flows through the photodiodes 421, 422. When light is inputted to one of the photodiodes 421, 422, no current flows through the photodiode 421 or 422 to which light is not inputted, and therefore no current flows through the photodiodes 421, 422. When light is inputted to both of the photodiodes 421, 422, a current flows through the photodiodes 421, 422. The other operations are similar to the operations of the apparatus shown in FIG. 8 and therefore will not be described further in detail.

In short, the logical product of optical signals inputted to the photodiodes 421, 422 is taken and an optical signal is outputted from the electroabsorption optical modulator 62.

### SEVENTH EMBODIMENT

Next, another embodiment of an OR circuit will be described with reference to FIG. 13. In FIG. 13, the same elements as those shown in FIG. 8 are denoted by the same symbols and numerals and will not be described further in detail.

In FIG. 13, photodiodes 423, 424 are provided instead of the photodiode 42. The photodiodes 423, 424 are connected in parallel and have different optical signals inputted thereto, respectively. That is, the photodiode 423 has its cathode connected to the voltage V3 and has its anode connected to the other end of the resistor R1. The photodiode 424 has its cathode connected to the voltage V3 and has its anode connected to the other end of the resistor R1.

The operation of this apparatus will be described. When light is inputted to neither of the photodiodes 423, 424, no current flows through the photodiodes 423, 424. When light is inputted to at least one of the photodiodes 423, 424, a current flows through one of the photodiode 423 or 424, to which light is inputted. The other operations are similar to the operations of the apparatus shown in FIG. 3 and therefore will not be described further in detail.

In short, the logical sum of optical signals inputted to the photodiodes 423, 424 is taken and an optical signal is outputted from the electroabsorption optical modulator 62.

Since logic can be taken by using the photodiodes 411 to 417, 421 to 424 as described above, logical operation can be carried out with a simple structure and at a high speed.

This invention is not limited to these embodiments. While the switch operation of the resonant tunneling diode 5 is outputted as light from the electroabsorption optical modulator 6 in the above-described structure, the switch operation of the resonant tunneling diode 5 may be taken out as an electrical signal. For example, a signal is taken out from connection point X shown in FIG. 3 or the connection point Y shown in FIG. 8.

While the voltages V1, V2 are described as different voltages, they may have the same voltage value. Similarly, the voltages V3, V4 may have the same voltage value. The voltages V5, V6 may have the same voltage value.

Although the logical circuits are shown in FIGS. 9 to 13, this invention is not limited to these logical circuits and logical circuits may be constituted by combining various photodiodes.

According to this invention, an optical signal is converted to an electrical signal by a photodiode and this electrical signal causes a resonant tunneling diode to perform switch operation. This switch operation enables provision of a digital signal. Therefore, this invention is advantageous in that high-speed operation can be realized with a small circuit scale.

Moreover, the switch operation of the resonant tunneling diode causes an optical modulator to change its transmittance and the optical modulator modulates light. Therefore, an optical repeater that operates at a high speed with a small circuit scale can be constructed.

Since logic can be taken by the photodiode, logical operation can be carried out at a high speed with a simple structure.

Moreover, since the photodiode and the like can be formed on the same semiconductor substrate, they can be formed in one chip.

What is claimed is:

1. An optical signal processing apparatus comprising:
at least one photodiode for converting an optical signal to an electrical signal; and
a resonant tunneling diode for having the electrical signal of this photodiode inputted thereto and performing switch operation;
wherein a digital signal is acquired by the switch operation of the resonant tunneling diode.

2. The optical signal processing apparatus as claimed in claim 1, comprising an optical modulator that changes its transmittance by the switch operation of the resonant tunneling diode and modulates and outputs light.

3. The optical signal processing apparatus as claimed in claim 1, wherein an electrical signal is acquired by the switch operation of the resonant tunneling diode.

4. An optical signal processing apparatus comprising:
at least one photodiode for converting an optical signal to an electrical signal;
a resistor having its one end connected to an anode of this photodiode; and
a resonant tunneling diode having one end connected to the one end of this resistor;
wherein a digital signal is acquired by switch operation of the resonant tunneling diode.

5. The optical signal processing apparatus as claimed in claim 4, comprising an optical modulator connected to the one end of the resonant tunneling diode, changing its transmittance, and modulating and outputting light.

6. The optical signal processing apparatus as claimed in claim 4, wherein an electrical signal is acquired from the one end of the resonant tunneling diode.

7. An optical signal processing apparatus comprising:
at least one photodiode for converting an optical signal to an electrical signal;
a first resistor having its one end connected to an anode of this photodiode;
a resonant tunneling diode having its one end connected to the one end of this resistor; and
a second resistor having its one end connected to the other end of the resonant tunneling diode;
wherein a digital signal is acquired by switch operation of the resonant tunneling diode.

8. The optical signal processing apparatus as claimed in claim 7, comprising an optical modulator connected to the other end of the resonant tunneling diode, changing its transmittance, and modulating and outputting light.

9. The optical signal processing apparatus as claimed in claim 7, wherein an electrical signal is acquired from the other end of the resonant tunneling diode.

10. The optical signal processing apparatus as claimed in one of claims 1 to 9, wherein the photodiodes are provided at least in parallel.

11. The optical signal processing apparatus as claimed in one of claims 1 to 9, wherein the photodiodes are provided at least in series.

12. The optical signal processing apparatus as claimed in one of claims 1 to 9, wherein at least the photodiode and the resonant tunneling diode are formed on the same semiconductor substrate.

13. The optical signal processing apparatus as claimed in one of claims 2, 5 and 8, wherein at least the photodiode, the resonant tunneling diode and the optical modulator are formed on the same semiconductor substrate.
